(19) United States
(12) Patent Application Publication
(10) Pub. No.: US 2024/0094453 A1
(43) Pub. Date: Mar. 21, 2024

(54) POLARIZED PARTITION, POLARIZED PARTITION SET, AND SPACE PARTITIONED USING SAME

(71) Applicant: NITTO DENKO CORPORATION, Ibaraki-shi, Osaka (JP)

(72) Inventors: Yuji Toyota, Ibaraki-shi, Osaka (JP); Yufeng Weng, Ibaraki-shi, Osaka (JP)

(73) Assignee: NITTO DENKO CORPORATION, Ibaraki-shi, Osaka (JP)

(21) Appl. No.: 18/274,235

(22) PCT Filed: Dec. 21, 2021
(86) PCT No.: PCT/JP2021/047305

§ 371 Date: Jul. 26, 2023

(30) Foreign Application Priority Data
Jan. 29, 2021 (JP) 2021-013200

(51) Int. Cl. G02B 5/30

(52) U.S. Cl. CPC G02B 5/3025; G02B 5/3083

(57) ABSTRACT

According to the present invention, a technology by which the design property of a section can be improved while a desired portion in the section is shielded can be achieved. The present invention provides a polarized partition set, including: a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and a second polarized partition, which includes a polarizer B and is arranged at a predetermined interval from the first polarized partition.

### TECHNICAL FIELD

The present invention relates to a polarized partition, a polarized partition set, and a section partitioned by using the same.

### BACKGROUND ART

In recent years, such design as described below has been performed for the purpose of achieving a bright and open working space or living space: a transparent window portion is arranged in part of a partition (including a wall and a door) for partitioning a space, or substantially the entire surface of the partition is made transparent (e.g., a floor-to-ceiling window).

Meanwhile, a case in which an image display apparatus, such as a personal computer, a television, or a monitor, is placed in such space as described above is not preferred in terms of information security and privacy because its displayed content may be observed from the outside.

In relation to the problems of information security and privacy in the image display apparatus described above, the following technology has been proposed (e.g., Patent Literature 1). A partition having a polarization characteristic is arranged so as to be capable of absorbing linearly polarized light emitted from the display screen of the image display apparatus, and hence an outsider present outside the partition is prevented from observing the display screen.

### CITATION LIST

### Patent Literature

[PTL 1] U.S. Pat. No. 6,552,850 B1

### SUMMARY OF INVENTION

### Technical Problem

In a section in which the display screen is shielded with such partition having a polarization characteristic as described in Patent Literature 1, while the spieled portion is observed in a black manner, the other portion is observed substantially under an as-is state. To cope with the problem, there has been required a technology by which a design property can be imparted to the section, and a desired portion in the section can be shielded as required.

The present invention has been made to solve the above-mentioned problem, and a primary object of the present invention is to achieve a technology by which the design property of a section can be improved while a desired portion in the section is shielded.

### Solution to Problem

According to one aspect of the present invention, there is provided a polarized partition set, including: a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and a second polarized partition, which includes a polarizer B and is arranged at a predetermined interval from the first polarized partition.

In one embodiment, the first polarized partition further includes a polarizer A2 on a side opposite to a side of the retardation layer on which the polarizer A1 is arranged.

In one embodiment, the first polarized partition is arranged so that the retardation layer is on a side closer to the second polarized partition with respect to the polarizer A1.

In one embodiment, the angle formed by the absorption axis direction of the polarizer A1 and the slow axis direction of the retardation layer in the first polarized partition is more than 10° and less than 80° clockwise or counterclockwise with respect to the absorption axis direction of the polarizer A1.

In one embodiment, the retardation layer has a configuration obtained by combining a plurality of retardation films.

According to another aspect of the present invention, there is provided a section, which is partitioned with a second polarized partition including a polarizer B, wherein the section includes arranged therein a first polarized partition including a polarizer A1 and a retardation layer having an in-plane retardation Re(550) of 100 nm or more, and wherein an angle formed by an absorption axis direction of the polarizer A1 and a slow axis direction of the retardation layer in the first polarized partition is more than 10° and less than 80°, or more than 100° and less than 170° clockwise or counterclockwise with respect to the absorption axis direction of the polarizer A1.

In one embodiment, the first polarized partition further includes a polarizer A2 on a side opposite to a side of the retardation layer on which the polarizer A1 is arranged.

In one embodiment, the section further includes an image display apparatus arranged on a side opposite to a side of the first polarized partition on which the second polarized partition is arranged, the image display apparatus being configured to emit linearly polarized light from a display screen thereof.

According to another aspect of the present invention, there is provided a section, which is partitioned with: a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and a second polarized partition including a polarizer B.

In one embodiment, the first polarized partition further includes a polarizer A2 on a side opposite to a side of the retardation layer on which the polarizer A1 is arranged.

According to another aspect of the present invention, there is provided a polarized partition, including a polarizer A1; and a retardation layer having an in-plane retardation Re(550) of 100 nm or more, wherein an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1.

According to another aspect of the present invention, there is provided a polarized partition, including in this order: a polarizer A1; a retardation layer having an in-plane retardation Re(550) of 100 nm or more; and a polarizer A2, wherein an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1.

### Advantageous Effects of Invention

According to the present invention, the first polarized partition including the polarizer A1 and the retardation layer, and the second polarized partition including the polarizer B are used in combination so that a chromatic polarization effect is obtained. Accordingly, there can be achieved the following section: the section has a design property, and at least part of the inside thereof can be shielded as required.

### BRIEF DESCRIPTION OF DRAWINGS

FIG. 1 is a schematic view of a section partitioned with a second polarized partition.

FIG. 2 is a schematic view of the section partitioned with the second polarized partition.

FIG. 3 is a schematic view of the section partitioned with first polarized partitions and the second polarized partition.

FIG. 4 is a schematic view of the section partitioned with the second polarized partition.

FIG. 5 is a schematic view of the section partitioned with the second polarized partition.

FIG. 6 is a schematic view of the section partitioned with the first polarized partition and the second polarized partition.

### DESCRIPTION OF EMBODIMENTS

Embodiments of the present invention are described below. However, the present invention is not limited to these embodiments.

A. Definitions of Terms (Definitions of Terms and Symbols)

The definitions of terms and symbols as used herein are as described below.

(1) Refractive Indices (nx, ny, and nz) “nx” represents a refractive index in a direction in which an in-plane refractive index is maximum (that is, slow axis direction), “ny” represents a refractive index in a direction perpendicular to the slow axis in the plane (that is, fast axis direction), and “nz” represents a refractive index in a thickness direction.

### (2) In-plane Retardation (Re)

“Re(λ)” refers to an in-plane retardation measured at 23° C. with light having a wavelength of λ nm. For example, “Re(550)” refers to an in-plane retardation measured at 23° C. with light having a wavelength of 550 nm. The Re(λ) is determined from the equation “Re(λ)=(nx-ny)×d” when the thickness of a layer (film) is represented by “d” (nm).

(3) The expression “perpendicular” as used herein encompasses not only a case in which an angle formed by two directions is strictly 90° but also a case in which the angle formed by the two directions is 90°±10°, and encompasses a case in which the angle is preferably 90°±7°, more preferably 90°±5°.
(4) The expression “parallel” as used herein encompasses not only a case in which an angle formed by two directions is strictly 0° but also a case in which the angle formed by the two directions is 0°±10°, and encompasses a case in which the angle is preferably 0°±7°, more preferably 0°±5°.

B. Polarized Partition Set

### B-1. Polarized Partition Set of First Embodiment

A polarized partition set of a first embodiment includes: a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and a second polarized partition, which includes a polarizer B and is arranged at a predetermined interval from the first polarized partition. In the polarized partition set of the first embodiment, the first polarized partition typically includes one polarizer.

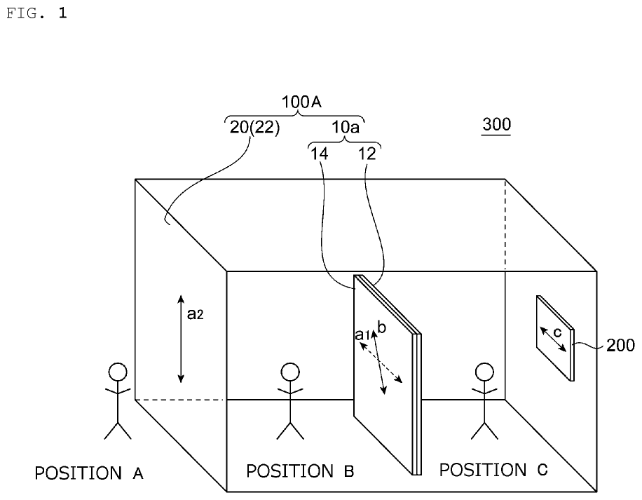

FIG. 1 is a schematic view of a section (room) 300 partitioned with the second polarized partition (floor-to-ceiling window) including the polarizer B, and is an illustration of a usage example of a polarized partition set 100A of the first embodiment. In the illustrated example, a first polarized partition (10a) including a polarizer A1 (12) and a retardation layer (14) having an in-plane retardation Re(550) of 100 nm or more, and a second polarized partition (20) including a polarizer B (22) are arranged with a predetermined interval therebetween, and the first polarized partition (10a) is arranged so that the retardation layer (14) is on the second polarized partition (20) side with respect to the polarizer A1 (12). In addition, an image display apparatus (200) is arranged on a side opposite to the side of the first polarized partition (10a) on which the second polarized partition (20) is arranged. In the figure, the arrow a1 indicates the absorption axis direction of the polarizer A1 (12), the arrow “b” indicates the slow axis direction of the retardation layer (14), the arrow a2 indicates the absorption axis direction of the polarizer B (22), and the arrow “c” indicates the vibration direction of linearly polarized light emitted from the display screen of the image display apparatus (200) (in other words, the transmission axis direction of the display screen).

In the first polarized partition (10a), the retardation layer (14) having an in-plane retardation Re(550) of 100 nm or more is arranged so that its slow axis direction (arrow “b”) forms an angle of more than 10° and less than 80°, or more than 100° and less than 170° clockwise or counterclockwise with respect to the absorption axis direction (arrow a1) of the polarizer A1 (12). The angle is preferably from 30° to 60°, or from 120° to 150°. With such configuration, light beams that have entered the first polarized partition (10a) and passed through the polarizer A1 (12) to become linearly polarized light beams are affected by the refractive index, birefringence, and wavelength dispersion characteristic of the retardation layer (14) to be emitted as partially polarized light beams whose polarized states vary from wavelength to wavelength from the retardation layer (14). Although part of the partially polarized light beams emitted from the retardation layer (14) are absorbed by the polarizer B (22) in the second polarized partition (20), their absorption amounts vary depending on their polarized states (in other words, depending on their wavelengths). As a result, the intensity of light that has passed through the second polarized partition (20) varies depending on its wavelength. Accordingly, the light that has passed through the second polarized partition (20) shows a spectral shape different from that of the light entering the polarizer A1 (12), and hence may be observed as colored light.

In addition, when the first polarized partition (10a) and the second polarized partition (20) are arranged so that an angle formed by the slow axis direction (arrow “b”) of the retardation layer (14) and the absorption axis direction (arrow a2) of the polarizer B (22) becomes more than 10° and less than 80°, or more than 100° and less than 170°, preferably from 30° to 60°, or from 120° to 150° clockwise or counterclockwise with respect to the absorption axis direction of the polarizer B (22), via the same mechanism as that described above, light that has passed through the polarizer B (22) in the second polarized partition (20) to become linearly polarized light may pass through the retardation layer (14) and the polarizer A1 (12) in the stated order to be observed as colored light. The angle formed by the absorption axis direction of the polarizer A1 (12) of the first polarized partition (10a) or the slow axis direction of the retardation layer (14) thereof and the absorption axis direction of the polarizer B (22) of the second polarized partition (20) is not limited as long as the effect of the present invention is obtained, and the angle may be set to any appropriate angle in accordance with a target color or the like. Specifically, the light beams that have passed through the polarizer A1 to become linearly polarized light beams pass through the retardation layer to be brought into polarized states that vary from wavelength to wavelength. Then, when the light beams pass through the polarizer B, their absorption amounts (transmission amounts) are determined in accordance with their polarized light components having the respective wavelengths, and a color to be exhibited is determined by a balance between the wavelengths of the transmitted light beams. Accordingly, the target color can be picked out by regulating each of: the angle formed by the absorption axis direction of the polarizer A1 and the slow axis direction of the retardation layer; and the angle formed by the slow axis direction of the retardation layer and the absorption axis direction of the polarizer B. The same holds true for light that has passed through the polarizer B, the retardation layer, and the polarizer A1 in the stated order.

Coloring caused by such a principle as described above is referred to as “chromatic polarization,” and desired coloring may be obtained by adjusting, for example, the in-plane retardation of the retardation layer (14), the angle formed by the slow axis direction of the retardation layer (14) and the absorption axis direction of the polarizer A1, the angle formed by the slow axis direction of the retardation layer (14) and the absorption axis direction of the polarizer B, and a viewing angle. A method of controlling the coloring in the chromatic polarization is specifically described in, for example, JP 2010-244059 A and JP 2000-275438 A. Specifically, for example, when a polycarbonate-based resin film having an Re(550) of from 550 nm to 600 nm and a positive wavelength dispersion characteristic is used as the retardation layer (14), and the angle formed by its slow axis direction and the absorption axis direction of the polarizer A1 (12) is about 45°, light that is colored yellow may be observed by forming the partition set so that the angle formed by the slow axis direction and the absorption axis direction of the polarizer B (22) becomes about 0°, and light that is colored blue may be observed by forming the partition set so that the angle becomes about 90°. In addition, when the retardation layer (14) having an Re(550) of from 820 nm to 880 nm is used, and the angle formed by its slow axis direction and the absorption axis direction of the polarizer A1 (12) is about 45°, light that is colored purple may be observed by forming the partition set so that the angle formed by the slow axis direction and the absorption axis direction of the polarizer B (22) becomes about 0°, and light that is colored green may be observed by forming the partition set so that the angle becomes about 90°.

In FIG. 1, the image display apparatus (200) may be arranged so that the vibration direction of the linearly polarized light emitted from its display screen and the absorption axis direction of the polarizer A1 (12) are parallel to each other. With such configuration, the linearly polarized light emitted from the display screen of the image display apparatus (200) is absorbed by the first polarized partition (10a). As a result, when the display screen is observed from a position A or a position B, contents displayed thereon are shielded.

The state of light to be observed by an observer at each position in the usage example illustrated in FIG. 1 is shown in Table 1. In the table, the term “Colored” means a state in which light colored by chromatic polarization may be observed, the term “Uncolored” means a state in which light that is not colored by the chromatic polarization is observed, and the term “Shielded” means a state in which the light is blocked and hence a black color is observed.

TABLE 1

| | Position from which | |
|---|---|---|
| | light to be observed | State of |
| Position of observer | is derived | light |
| A | B | Uncolored |
| (Side opposite to side of second | C | Colored |
| polarized partition on which first | Display screen | Shielded*¹ |
| polarized partition is arranged) | | |
| B | A | Uncolored |
| (Between first polarized partition | C | Uncolored |
| and second polarized partition) | Display screen | Shielded*² |
| C | A | Colored*³ |
| (Side opposite to side of first | B | Uncolored |
| polarized partition on which second | Display screen | Uncolored |
| polarized partition is arranged) | | |

*¹The state is “colored” when the vibration direction of the linearly polarized light derived from the image display apparatus and the absorption axis direction of the polarizer A1 are not parallel to each other.
*²The state is “uncolored” when the vibration direction of the linearly polarized light derived from the image display apparatus and the absorption axis direction of the polarizer A1 are not parallel to each other.
*³The state is “uncolored” when the absorption axis direction of the polarizer B and the slow axis direction of a retardation film are parallel or perpendicular to each other.

As shown in Table 1, the observer present between the first polarized partition (10a) and the second polarized partition (20) (the position B), and the observer present outside the section (the position A) cannot view the display screen of the image display apparatus, and hence privacy protection and an improvement in security can be achieved. In addition, the design property of the section can be improved because the light that has passed through the first polarized partition may be viewed as colored light by the observer present outside the section (the position A).

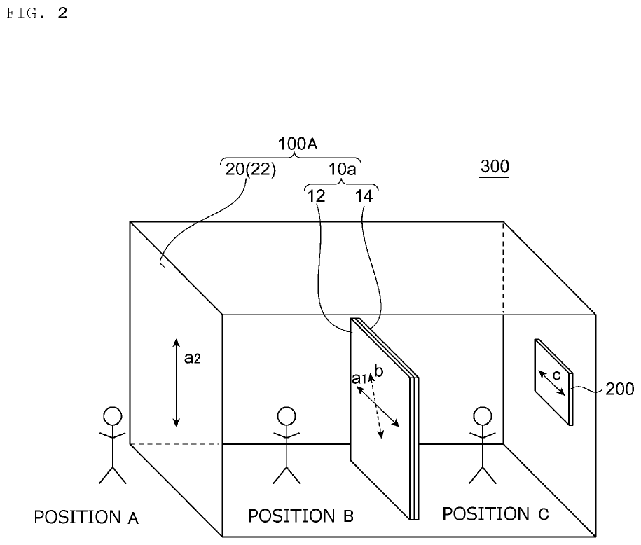

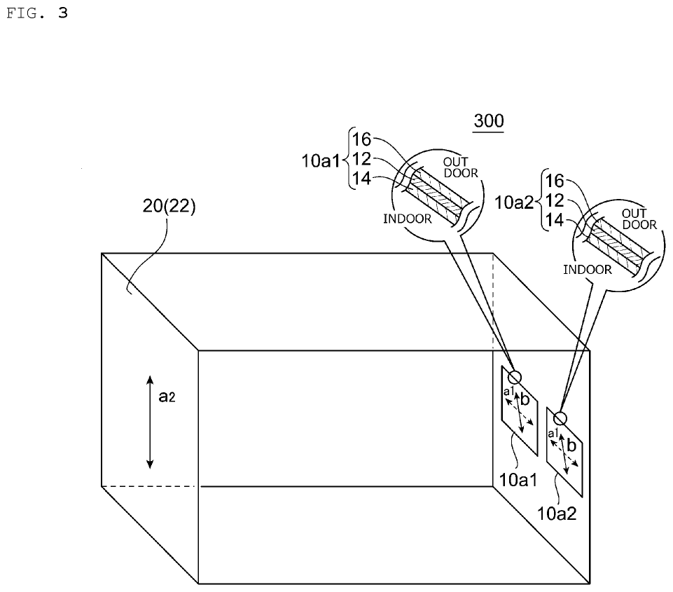

FIG. 2 is a schematic view of the section (room) 300 partitioned with the second polarized partition (floor-to-ceiling window) including the polarizer B, and is an illustration of another usage example of the polarized partition set 100A of the first embodiment. In FIG. 2, constituent elements identical or corresponding to those of FIG. 1 are given the same reference symbols, and the repetition of their description may be omitted. The same holds true for FIG. 3 to FIG. 6.

In FIG. 2, the first polarized partition (10a) including the polarizer A1 (12) and the retardation layer (14), and the second polarized partition (20) including the polarizer B (22) are arranged with a predetermined interval therebetween, and the first polarized partition (10a) is arranged so that the polarizer A1 (12) is on the second polarized partition (20) side with respect to the retardation layer (14). In addition, the first polarized partition (10a) and the second polarized partition (20) are arranged so that the absorption axis direction of the polarizer A1 (12) and the absorption axis direction of the polarizer B (22) are perpendicular to each other. Further, the image display apparatus (200) is arranged on the side opposite to the side of the first polarized partition (10a) on which the second polarized partition (20) is arranged.

In FIG. 2, the image display apparatus (200) may be arranged so that the vibration direction of the linearly polarized light emitted from its display screen and the absorption axis direction of the polarizer A1 (12) are parallel to each other. With such configuration, the linearly polarized light emitted from the display screen of the image display apparatus (200) is absorbed by the first polarized partition (10a). As a result, contents displayed on the display screen are shielded.

The state of light to be observed by an observer at each position in the usage example illustrated in FIG. 2 is shown in Table 2. In the table, the term “Colored” means a state in which light colored by chromatic polarization may be observed, the term “Uncolored” means a state in which light that is not colored by the chromatic polarization is observed, and the term “Shielded” means a state in which the light is blocked and hence a black color is observed.

TABLE 2

| | Position from which | |
|---|---|---|
| | light to be observed | |
| Position of observer | is derived | State of light |
| A | B | Uncolored |
| | C | Shielded |
| | Display screen | Shielded |
| B | A | Uncolored |
| | C | Uncolored |
| | Display screen | Colored*¹ |
| C | A | Shielded |
| | B | Uncolored |
| | Display screen | Uncolored |

*¹The state is “uncolored” when the vibration direction of the linearly polarized light derived from the image display apparatus and the slow axis direction of the retardation layer are perpendicular or parallel to each other.

FIG. 3 is a schematic view (including schematic sectional views of the first polarized partitions) of the section (room) 300 partitioned with the first polarized partitions and the second polarized partition, and is an illustration of another usage example of the polarized partition set of the first embodiment. In the illustrated example, first polarized partitions (10a1, 10a2), which each include the polarizer A1 (12), the retardation layer (14), and a transparent substrate (16), and each function as a windowpane, and the second polarized partition (20) including the polarizer B (22) and functioning as a floor-to-ceiling window are arranged with a predetermined interval therebetween. The first polarized partitions (10a1, 10a2) are each arranged so that the retardation layer (14) is on the second polarized partition (20) side with respect to the polarizer A1 (12). An angle formed by the absorption axis direction of the polarizer A1 (12) of each of the first polarized partitions (10a) or the slow axis direction of the retardation layer (14) thereof and the absorption axis direction of the polarizer B (22) of the second polarized partition (20) is not limited as long as the effect of the present invention is obtained, and the angle may be set to any appropriate angle.

In the usage example illustrated in FIG. 3, ambient light passes through the first polarized partition (10a1, 10a2), and the second polarized partition in the stated order (more specifically, the polarizer A1 (12), the retardation layer (14), and the polarizer B (22) in the stated order) to cause a chromatic polarization phenomenon. As a result, in the case of observation from the outside of the section, colored light may be observed. Meanwhile, in the section, the coloring of the ambient light does not occur because the chromatic polarization phenomenon does not occur.

For example, when the retardation layers (14) having different in-plane retardations are used for the first polarized partition (10a1) and the first polarized partition (10a2), or the partitions are made different from each other in angle formed by the absorption axis direction of the polarizer A1 (12) and/or the absorption axis direction of the polarizer B (22), and the slow axis direction of the retardation layer (14), in the case of observation from the outside of the section, light beams that have passed through the first polarized partition (10a1) and the first polarized partition (10a2) can be viewed as light beams colored to colors different from each other.

In addition, a reflective substrate may be used instead of the transparent substrate (16). According to the first polarized partition having such configuration, light that has entered the first polarized partition (10a1, 10a2) from an indoor side is reflected by the reflective substrate to pass through the polarizer A1 (12), the retardation layer (14), and the polarizer B (22) in the stated order, to thereby cause a chromatic polarization phenomenon. As a result, in the case of observation from the outside of the section, colored light may be observed.

The first polarized partition (10a) and the second polarized partition (20) for forming the polarized partition set of the first embodiment are specifically described below.

B-1-1. First Polarized Partition

The first polarized partition (10a) includes the polarizer A1 (12) and the retardation layer (14) having an in-plane retardation Re(550) of 100 nm or more, and typically further includes the transparent substrate (16). The order in which those components are laminated is not limited, and the configuration [polarizer A1/retardation layer/transparent substrate], the configuration [retardation layer/polarizer A1/transparent substrate], or the configuration [polarizer A1/transparent substrate/retardation layer] may be adopted. In addition, the first polarized partition (10a) is formed so that the angle formed by the absorption axis direction of the polarizer A1 (12) and the slow axis direction of the retardation layer (14) becomes more than 10° and less than 80°, or more than 100° and less than 170°, preferably from 30° to 60°, or from 120° to 150° clockwise or counterclockwise with respect to the absorption axis direction of the polarizer A1 (12). In addition, as described above, a reflective substrate may be used instead of the transparent substrate in accordance with purposes.

The first polarized partition (10a) may further include a constituent element, such as a protective film or a support film, in accordance with purposes, and the respective constituent elements for forming the first polarized partition (10a) are bonded to each other via an adhesive layer or a pressure-sensitive adhesive layer as required. Accordingly, in one embodiment, the first polarized partition (10a) may be obtained by bonding the laminate of a polarizing plate, which includes the polarizer A1 (12) and the protective film arranged on at least one side thereof, and the retardation layer (14) to the transparent substrate via the pressure-sensitive adhesive layer or the adhesive layer.

The first polarized partition (10a) is not limited as long as the partition can partition a space, and the partition may be in any appropriate form, such as a movable form or a fixed form. Specific examples of the first polarized partition (10a) include a desktop-type partition, a suspension-type partition, a screen-type partition, a window, a door, and a wall. In recent years, from the viewpoints of measures against infections, a working region such as a desk has been partitioned with a desktop partition. The use of a related-art desktop partition such as an acrylic resin plate causes a problem in that when the partition is combined with the second polarized partition, the retardation of the resin plate results in the dissolution of a shielding effect on an image display apparatus. However, such problem can be solved by using the first polarized partition and the second polarized partition according to the embodiment of the present invention in combination.

B-1-1-1. Polarizer A1

The polarizer A1 is typically formed from a polyvinyl alcohol-based resin film containing a dichroic substance (e.g., iodine). The polarizer A1 may be formed from a single-layer resin film, or may be produced by using a laminate of two or more layers.

Specific examples of the polarizer formed from a single-layer resin film include: a polarizer obtained by subjecting a hydrophilic polymer film, such as a polyvinyl alcohol (PVA)-based film, a partially formalized PVA-based film, or an ethylene-vinyl acetate copolymer-based partially saponified film, to dyeing treatment with a dichroic substance, such as iodine or a dichroic dye, and stretching treatment; and a polyene-based alignment film, such as a dehydration-treated product of PVA or a dehydrochlorination-treated product of polyvinyl chloride. A polarizer obtained by dyeing the PVA-based film with iodine and uniaxially stretching the resultant is preferably used because the polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching has been performed. The PVA-based film is subjected to swelling treatment, cross-linking treatment, washing treatment, drying treatment, or the like as required. For example, when the PVA-based film is immersed in water to be washed with water before the dyeing, contamination or an antiblocking agent on the surface of the PVA-based film can be washed off. In addition, the PVA-based film is swollen and hence dyeing unevenness or the like can be prevented.

A specific example of the polarizer obtained by using a laminate is a polarizer obtained by using a laminate of a resin substrate and a PVA-based resin layer (PVA-based resin film) laminated on the resin substrate or a laminate of a resin substrate and a PVA-based resin layer formed on the resin substrate through application. The polarizer obtained by using the laminate of the resin substrate and the PVA-based resin layer formed on the resin substrate through application may be produced, for example, by: applying a PVA-based resin solution to the resin substrate; drying the solution to form the PVA-based resin layer on the resin substrate, to thereby provide the laminate of the resin substrate and the PVA-based resin layer; and stretching and dyeing the laminate to turn the PVA-based resin layer into the polarizer. In this embodiment, the stretching typically includes stretching of the laminate under a state in which the laminate is immersed in an aqueous solution of boric acid. Further, the stretching may further include in-air stretching of the laminate at high temperature (e.g., 95° C. or more) before the stretching in the aqueous solution of boric acid as required. The resultant laminate of the resin substrate and the polarizer may be used as it is (i.e., the resin substrate may be used as a protective layer for the polarizer). Alternatively, a product obtained as described below may be used: the resin substrate is peeled from the laminate of the resin substrate and the polarizer, and any appropriate protective layer in accordance with purposes is laminated on the peeling surface. Details about such method of producing the polarizer are described in, for example, JP 2012-73580 A, the description of which is incorporated herein by reference in its entirety.

The thickness of the polarizer A1 is, for example, 30 μm or less, preferably 15 μm or less, more preferably from 1 μm to 12 μm, still more preferably from 2 μm to 10 μm, particularly preferably from 2 μm to 8 μm.

The polarizer A1 preferably shows absorption dichroism at any wavelength in the wavelength range of from 380 nm to 780 nm. The single layer transmittance of the polarizer A1 is preferably from 43.0% to 46.0%, more preferably from 44.5% to 46.0%. The polarization degree of the polarizer A1 is preferably 97.0% or more, more preferably 99.0% or more, still more preferably 99.9% or more.

As described above, the polarizer A1 may be used as a polarizing plate in which the protective film is arranged on at least one side of the polarizer. The protective film includes any appropriate film that may be used as a protective film for the polarizer. As a material serving as a main component of the film, there are specifically given, for example, cellulose-based resins such as triacetylcellulose (TAC), and transparent resins, such as polyester-based, polyvinyl alcohol-based, polycarbonate-based, polyamide-based, polyimide-based, polyether sulfone-based, polysulfone-based, polystyrene-based, polynorbornene-based, polyolefin-based, cyclic olefin-based, (meth)acrylic, and acetate-based resins. There are also given, for example, thermosetting resins or UV-curable resins, such as (meth)acrylic, urethane-based, (meth)acrylic urethane-based, epoxy-based, and silicone-based resins. There are also given, for example, glassy polymers such as a siloxane-based polymer. In addition, a polymer film described in JP 2001-343529 A (WO 01/37007 A1) may be used. For example, a resin composition containing a thermoplastic resin having a substituted or unsubstituted imide group on a side chain thereof, and a thermoplastic resin having a substituted or unsubstituted phenyl group and a nitrile group on side chains thereof may be used as a material for the film, and the composition is, for example, a resin composition containing an alternating copolymer formed of isobutene and N-methylmaleimide, and an acrylonitrile-styrene copolymer. The polymer film may be, for example, an extrudate of the resin composition. A (meth)acrylic resin or a cyclic olefin-based resin may be preferably used.

B-1-1-2. Retardation Layer

The in-plane retardation Re(550) of the retardation layer is typically 100 nm or more, preferably from 130 nm to 8,000 nm, more preferably from 200 nm to 4,000 nm. When the Re(550) of the retardation layer falls within the ranges, a chromatic polarization phenomenon can be suitably caused. A desired value in the ranges may be selected as the Re(550) of the retardation layer in accordance with desired coloring.

A retardation layer having any appropriate wavelength dispersion characteristic (specifically, such a positive wavelength dispersion characteristic that the birefringence (Δn) of the layer becomes smaller as the wavelength of light entering the layer lengthens, such a negative wavelength dispersion characteristic (reverse wavelength dispersion characteristic) that the birefringence becomes larger as the wavelength lengthens, or such a flat dispersion characteristic that the layer shows a constant birefringence irrespective of the wavelength) may be used as the retardation layer in accordance with a color desired as a result of the chromatic polarization phenomenon.

The retardation layer has an in-plane retardation as described above, and hence has a relationship of nx>ny. The retardation layer shows any appropriate refractive index ellipsoid as long as the retardation layer has a relationship of nx>ny. The refractive index ellipsoid of the retardation layer preferably shows a relationship of nx>ny≥nz.

The retardation layer may be a resin film (typically a stretched film of the resin film) or a liquid crystal alignment fixed layer that may satisfy such characteristics as described above. Typical examples of the resin for forming the retardation layer include a polyester-based resin (e.g., polyethylene terephthalate or polyethylene naphthalate), a polycarbonate-based resin, a polyether-based resin (e.g., polyether ether ketone), a polystyrene-based resin, and a cyclic olefin-based resin. In particular, a polyester-based resin and a polycarbonate-based resin may each be suitably used because each of the resins has a large intrinsic birefringence, and relatively easily provides a large in-plane retardation even when its stretching ratio is low or its thickness is small.

The retardation layer that is a stretched film of a resin film may be obtained by stretching the above-mentioned resin film. Any appropriate stretching method and stretching conditions (e.g., a stretching temperature, a stretching ratio, and a stretching direction) may be adopted for the stretching in accordance with a desired in-plane retardation (finally, a desired color of the background color).

The retardation layer may have any appropriate configuration as long as a chromatic polarization phenomenon may occur when the polarizer A1 and the polarizer B are used in combination. For example, the retardation layer may be a single layer, or may have a laminated structure in which a plurality of retardation films (e.g., stretched films of resin films or liquid crystal alignment fixed layers) are laminated. The retardation layer that is a laminate has an advantage in that its in-plane retardation is easy to adjust. Specifically, when the plurality of retardation films are laminated so that their slow axis directions are parallel to each other, a retardation layer in which their phase values are added to each other can be obtained, and when the films are laminated so that the slow axis directions are perpendicular to each other, a retardation layer in which the phase values are subtracted from each other can be obtained. In addition, the wavelength dispersion characteristic of the layer can be changed by laminating the films while shifting the slow axis directions from each other. Any appropriate number of retardation films may be laminated at any appropriate site of the retardation layer in accordance with purposes. In addition, even in the case of, for example, a single-layer retardation layer, the application of retardation films having different in-plane retardations in a plurality of regions can provide light beams colored to colors that vary from region to region. In addition/alternatively, when the retardation films are arranged in combination (subjected to patchwork) in the plurality of regions so that the slow axis directions are different from each other, light beams colored to colors that vary from region to region can be obtained. When the retardation layer has a configuration in which the plurality of retardation films are combined by lamination, patchwork arrangement, or the like as described above, the options of colors to be picked out widen, and a desired color may be picked out at any appropriate site in any appropriate shape. Accordingly, a complicated design, such as a painting or a pattern, may be formed. When the retardation layer has a configuration in which the plurality of retardation films are combined, at least part of the retardation layer only needs to satisfy the above-mentioned optical characteristics.

The thickness of the retardation layer (in the case of a laminate, its total thickness) may be appropriately set in accordance with, for example, a desired in-plane retardation and a constituent material.

A commercial retardation film may be used as the retardation layer (retardation film), or the commercial retardation film may be used as the retardation layer (retardation film) by being subjected to secondary processing (e.g., stretching).

B-1-1-3. Transparent Substrate

Any appropriate substrate may be used as the transparent substrate (16) as long as the effect of the present invention is obtained. The total light transmittance of the transparent substrate (16) may be, for example, 70% or more, preferably 85% or more.

Preferred examples of a material for forming the transparent substrate (16) may include resin materials, such as a (meth)acrylic resin, a polyester-based resin, and a polycarbonate-based resin, and glass.

B-1-1-4. Reflective Substrate

Any appropriate substrate may be used as the reflective substrate as long as the effect of the present invention is obtained. The total light reflectance of the reflective substrate may be, for example, 70% or more, preferably 85% or more.

B-1-2. Second Polarized Partition

The second polarized partition (20) includes the polarizer B (22), and typically further includes a transparent substrate.

The second polarized partition (20) may further include a constituent element, such as a protective film or a support film, in accordance with purposes, and the respective constituent elements for forming the second polarized partition (20) are bonded to each other via an adhesive layer or a pressure-sensitive adhesive layer as required. Accordingly, in one embodiment, the second polarized partition (20) may be obtained by bonding a polarizing plate, which includes the polarizer B (22) and the protective film arranged on at least one side thereof, to the transparent substrate via the pressure-sensitive adhesive layer or the adhesive layer.

The second polarized partition (20) is not limited as long as the partition can partition a space, and the partition may be in any appropriate form, such as a movable form or a fixed form. Specific examples of the second polarized partition (20) include a desktop-type partition, a suspension-type partition, a screen-type partition, a window, a door, and a wall.

The same descriptions as those of the polarizer A1 (12) and the transparent substrate (16) for forming the first polarized partition may be applied to the polarizer B (22) and the transparent substrate, respectively. In the second polarized partition, the polarizer B (22) may be arranged so that its absorption axis direction forms a desired angle with the absorption axis direction of the polarizer A1 (12) for forming the first polarized partition and/or the slow axis direction of the retardation layer (14) for forming the partition.

### B-2. Polarized Partition Set of Second Embodiment

A polarized partition set of a second embodiment includes: a first polarized partition, which includes a polarizer A1, a retardation layer having an in-plane retardation Re(550) of 100 nm or more, and a polarizer A2 in the stated order, and in which an angle formed by the absorption axis direction of the polarizer A1 and the slow axis direction of the retardation layer is more than 10° and less than 80°, or more than 100° and less than 170° clockwise or counterclockwise with respect to the absorption axis direction of the polarizer A1; and a second polarized partition, which includes a polarizer B and is arranged at a predetermined interval from the first polarized partition. In the polarized partition set of the second embodiment, the first polarized partition typically includes two polarizers. In addition, the first polarized partition may be arranged so that the retardation layer is on a side closer to the second polarized partition with respect to the polarizer A1.

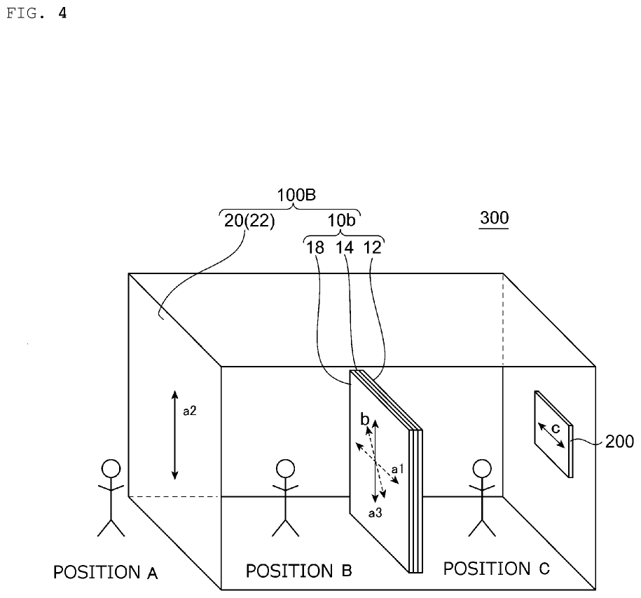

FIG. 4 is a schematic view of the section (room) 300 partitioned with the second polarized partition (floor-to-ceiling window) including the polarizer B, and is an illustration of a usage example of a polarized partition set 100B of the second embodiment. In the illustrated example, a first polarized partition (10b) including the polarizer A1 (12), the retardation layer (14) having an in-plane retardation Re(550) of 100 nm or more, and the polarizer A2 (18) in the stated order, and the second polarized partition (20) including the polarizer B (22) are arranged with a predetermined interval therebetween. The first polarized partition (10b) is arranged so that the retardation layer (14) is on the second polarized partition (20) side with respect to the polarizer A1 (12). The first polarized partition (10b) and the second polarized partition (20) are arranged so that the absorption axis direction of the polarizer A2 (18) and the absorption axis direction of the polarizer B (22) are parallel to each other. In addition, the image display apparatus (200) is arranged on a side opposite to the side of the first polarized partition (10b) on which the second polarized partition (20) is arranged. In the figure, the arrow a1 indicates the absorption axis direction of the polarizer A1 (12), the arrow “b” indicates the slow axis direction of the retardation layer (14), the arrow a2 indicates the absorption axis direction of the polarizer B (22), the arrow “c” indicates the vibration direction of linearly polarized light emitted from the display screen of the image display apparatus (200), and the arrow a3 indicates the absorption axis direction of the polarizer A2 (18).

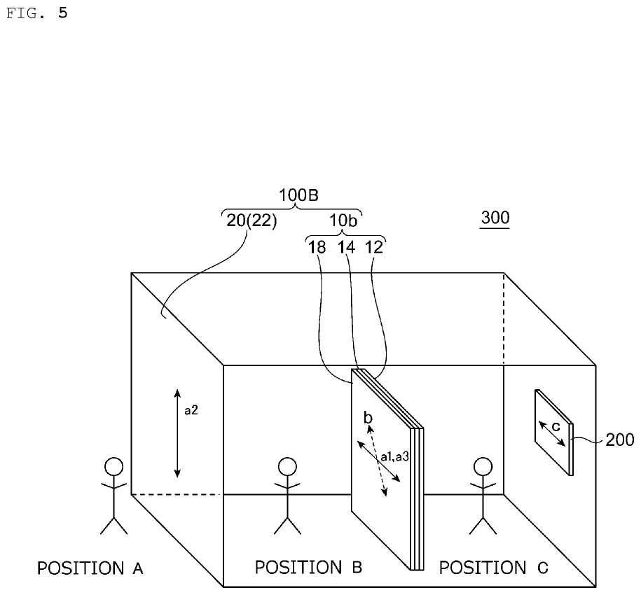

In the first polarized partition (10b), the retardation layer (14) having an in-plane retardation Re(550) of 100 nm or more is arranged so that its slow axis direction (arrow “b”) forms an angle of more than 10° and less than 80°, or more than 100° and less than 170° clockwise or counterclockwise with respect to the absorption axis direction (arrow a1) of the polarizer A1 (12). The angle is preferably from 30° to 60°, or from 120° to 150°. With such configuration, light beams that have entered the first polarized partition (10b) and passed through the polarizer A1 (12) to become linearly polarized light beams are affected by the refractive index, birefringence, and wavelength dispersion characteristic of the retardation layer (14) to be emitted as partially polarized light beams whose polarized states vary from wavelength to wavelength from the retardation layer (14). Although part of the partially polarized light beams emitted from the retardation layer (14) are absorbed by the polarizer A2 (18), their absorption amounts vary depending on their polarized states (in other words, depending on their wavelengths). As a result, the intensity of light that has passed through the first polarized partition (10b) varies depending on its wavelength. Accordingly, the light emitted from the polarizer A2 (18) shows a spectral shape different from that of the light entering the polarizer A1 (12), and hence may be observed as colored light. In addition, the first polarized partition (10b) and the second polarized partition (20) are arranged so that the absorption axis direction of the polarizer A2 (18) and the absorption axis direction of the polarizer B (22) are parallel to each other. Accordingly, the colored light can pass through the second polarized partition (20) under an as-is state. Unlike the illustrated example, the absorption axis direction of the polarizer A2 (18) and the absorption axis direction of the polarizer B (22) may be in a state except a parallel state (FIG. 5 is an illustration of a perpendicular state).

In addition, when the first polarized partition (10b) is formed so that an angle formed by the slow axis direction (arrow “b”) of the retardation layer (14) and the absorption axis direction (arrow a3) of the polarizer A2 (18) becomes more than 10° and less than 80°, or more than 100° and less than 170°, preferably from 30° to 60°, or from 120° to 150° clockwise or counterclockwise with respect to the absorption axis direction of the polarizer A2 (18), via the same mechanism as that described above, light that has passed through the polarizer A2 (18) of the first polarized partition (10b) to become linearly polarized light may pass through the retardation layer (14) and the polarizer A1 (12) in the stated order to be observed as colored light. In the first polarized partition (10b), the angle formed by the absorption axis direction of the polarizer A1 (12) or the slow axis direction of the retardation layer (14) and the absorption axis direction of the polarizer A2 (18) is not limited as long as the effect of the present invention is obtained, and the angle may be set to any appropriate angle.

In FIG. 4, the image display apparatus (200) may be arranged so that the vibration direction of the linearly polarized light emitted from its display screen and the absorption axis direction of the polarizer A1 (12) are parallel to each other. With such configuration, the linearly polarized light emitted from the display screen of the image display apparatus (200) is absorbed by the first polarized partition (10b). As a result, contents displayed on the display screen are shielded.

The state of light to be observed by an observer at each position in the usage example illustrated in FIG. 4 is shown in Table 3. In the table, the term “Colored” means a state in which light colored by chromatic polarization may be observed, the term “Uncolored” means a state in which light that is not colored by the chromatic polarization is observed, and the term “Shielded” means a state in which the light is blocked and hence a black color is observed.

TABLE 3

| | Position from which | |
|---|---|---|
| | light to be observed | |
| Position of observer | is derived | State of light |
| A | B | Uncolored |
| | C | Colored |
| | Display screen | Shielded*¹ |
| B | A | Uncolored |
| | C | Colored |
| | Display screen | Shielded*¹ |
| C | A | Colored*² |
| | B | Colored*² |
| | Display screen | Uncolored |

*¹The state is “colored” when the vibration direction of the linearly polarized light derived from the image display apparatus and the absorption axis direction of the polarizer A1 are not parallel to each other.
*²The state is “uncolored” when the absorption axis direction of the polarizer A2 and the slow axis direction of the retardation layer are parallel or perpendicular to each other.

FIG. 5 is a schematic view of the section (room) 300 partitioned with the second polarized partition including the polarizer B, and is an illustration of another usage example of the polarized partition set 100B of the second embodiment. In the illustrated example, the first polarized partition (10b) including the polarizer A1 (12), the retardation layer (14) having an in-plane retardation Re(550) of 100 nm or more, and the polarizer A2 (18) in the stated order, and the second polarized partition (20) including the polarizer B (22) are arranged with a predetermined interval therebetween. The first polarized partition (10b) is arranged so that the retardation layer (14) is on the second polarized partition (20) side with respect to the polarizer A1 (12). The first polarized partition (10b) and the second polarized partition (20) are arranged so that the absorption axis direction of the polarizer A2 (18) and the absorption axis direction of the polarizer B (22) are perpendicular to each other. In addition, the image display apparatus (200) is arranged on a side opposite to the side of the first polarized partition (10b) on which the second polarized partition (20) is arranged.

In the usage example illustrated in FIG. 5, as in the usage example illustrated in FIG. 4, light that has entered from the polarizer A1 (12) side and passed through the first polarized partition (10b) may be observed as colored light. Meanwhile, the first polarized partition (10b) and the second polarized partition (20) are arranged so that the absorption axis direction of the polarizer A2 (18) and the absorption axis direction of the polarizer B (22) are perpendicular to each other. Accordingly, the colored light is absorbed by the second polarized partition (20).

In addition, when the first polarized partition (10b) is formed so that the angle formed by the slow axis direction (arrow “b”) of the retardation layer (14) and the absorption axis direction (arrow a3) of the polarizer A2 (18) becomes more than 10° and less than 80°, or more than 100° and less than 170°, preferably from 30° to 60°, or from 120° to 150° clockwise or counterclockwise with respect to the absorption axis direction of the polarizer A2 (18), light that has entered from the polarizer A2 (18) side and passed through the first polarized partition (10b) may be observed as colored light. In the first polarized partition (10b), the angle formed by the absorption axis direction of the polarizer A1 (12) or the slow axis direction of the retardation layer (14) and the absorption axis direction of the polarizer A2 (18) is not limited as long as the effect of the present invention is obtained, and the angle may be set to any appropriate angle.

In FIG. 5, the image display apparatus (200) may be arranged so that the vibration direction of the linearly polarized light emitted from its display screen and the absorption axis direction of the polarizer A1 (12) are parallel to each other. With such configuration, the linearly polarized light emitted from the display screen of the image display apparatus (200) is absorbed by the first polarized partition (10b). As a result, contents displayed on the display screen are shielded.

The state of light to be observed by an observer at each position in the usage example illustrated in FIG. 5 is shown in Table 4. In the table, the term “Colored” means a state in which light colored by chromatic polarization may be observed, the term “Uncolored” means a state in which light that is not colored by the chromatic polarization is observed, and the term “Shielded” means a state in which the light is blocked and hence a black color is observed.

TABLE 4

| | Position from which | |
|---|---|---|
| | light to be observed | |
| Position of observer | is derived | State of light |
| A | B | Uncolored |
| | C | Shielded |
| | Display screen | Shielded |
| B | A | Uncolored |
| | C | Colored |
| | Display screen | Shielded*¹ |
| C | A | Shielded |
| | B | Colored*² |
| | Display screen | Uncolored |

*¹The state is “colored” when the vibration direction of the linearly polarized light derived from the image display apparatus and the absorption axis direction of the polarizer A1 are not parallel to each other.
*²The state is “uncolored” when the absorption axis direction of the polarizer A2 and the slow axis direction of the retardation layer are parallel or perpendicular to each other.

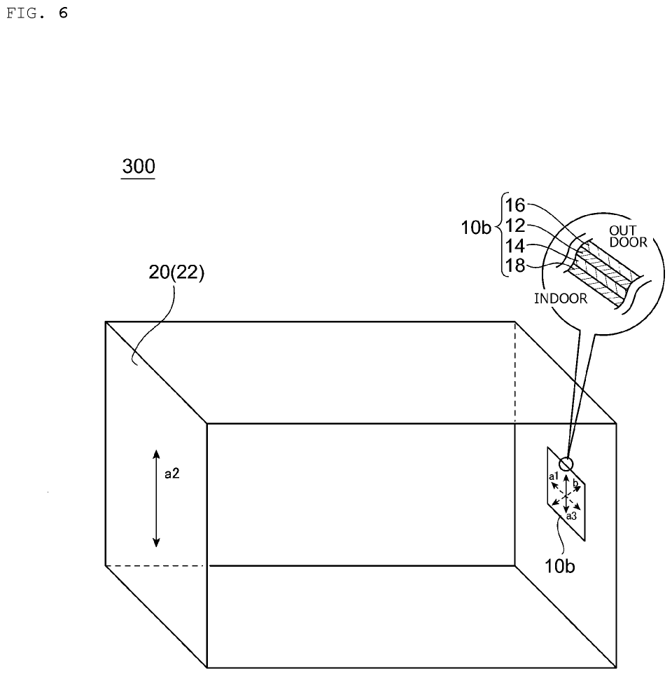

FIG. 6 is a schematic view (including a schematic sectional view of the first polarized partition) of the section (room) 300 partitioned with the first polarized partition and the second polarized partition, and is an illustration of another usage example of the polarized partition set of the second embodiment. In the illustrated example, the first polarized partition (10b) including the polarizer A1 (12), the retardation layer (14), the polarizer A2 (18), and the transparent substrate (16) and functioning as a windowpane, and the second polarized partition (20) including the polarizer B (22) and functioning as a floor-to-ceiling window are arranged with a predetermined interval therebetween. The first polarized partition (10b) is arranged so that the retardation layer (14) is on the second polarized partition (20) side with respect to the polarizer A1 (12), and so that the absorption axis direction of the polarizer A2 (18) and the absorption axis direction of the polarizer B (22) are parallel to each other.

In the usage example illustrated in FIG. 6, ambient light passes through the first polarized partition (10b) (more specifically, passes through the polarizer A1 (12), the retardation layer (14), and the polarizer A2 (18) in the stated order) to cause a chromatic polarization phenomenon. As a result, when the outside of the window is observed from the inside of the room, colored light may be observed. In addition, the second polarized partition (20) is arranged so that the absorption axis direction of the polarizer A2 (18) and the absorption axis direction of the polarizer B (22) are parallel to each other. Accordingly, the colored light can be observed at a high transmittance even from the outside of the room. As described with regard to FIG. 3, when a reflective substrate is used instead of the transparent substrate (16), the chromatic polarization phenomenon can be caused by using light that has entered the first polarized partition from an indoor side.

In each of the usage examples illustrated in FIG. 1 to FIG. 6, the first polarized partition and the second polarized partition are arranged so that the directions in which their respective main surfaces extend are parallel to each other. However, the partitions may be arranged in any appropriate positional relationship as long as the effect of the present invention is obtained.

The first polarized partition (10b) and the second polarized partition (20) for forming the polarized partition set of the second embodiment are specifically described below.

B-2-1. First Polarized Partition

The first polarized partition (10b) in the polarized partition set of the second embodiment has the following configuration: in the first polarized partition (10a) in the polarized partition set of the first embodiment, the polarizer A2 (18) is arranged on a side opposite to the side of the retardation layer (14) on which the polarizer A1 (12) is arranged.

In the first polarized partition (10b), the angle formed by the slow axis direction of the retardation layer (14) and the absorption axis direction of the polarizer A2 (18) may be appropriately set in accordance with purposes. When the angle is, for example, more than 10° and less than 80°, or more than 100° and less than 170°, preferably from 30° to 60°, or from 120° to 150° clockwise or counterclockwise with respect to the absorption axis direction of the polarizer A2 (18), a chromatic polarization phenomenon may also occur for light that enters from the polarizer A2 (18) side and is emitted from the polarizer A1 (12) side. However, the angle formed by the absorption axis direction of the polarizer A1 (12) or the slow axis direction of the retardation layer (14) and the absorption axis direction of the polarizer A2 (18) is not limited as long as the effect of the present invention is obtained, and the angle may be set to any appropriate angle.

The same polarizer as the polarizer A1 (12) may be used as the polarizer A2 (18), and the polarizer A2 (18) may be used in the form of a polarizing plate in which a protective film is arranged on at least one side of the polarizer.

B-2-2. Second Polarized Partition

The same description as that of the second polarized partition in the polarized partition set of the first embodiment may be applied to the second polarized partition in the polarized partition set of the second embodiment.

C. Section

According to another aspect of the present invention, there is provided a section partitioned with a second polarized partition including a polarizer B.

In one embodiment, a first polarized partition including a polarizer A1 and a retardation layer having an in-plane retardation Re(550) of 100 nm or more is arranged in the above-mentioned section, and an angle formed by the absorption axis direction of the polarizer A1 and the slow axis direction of the retardation layer is more than 10° and less than 80°, or more than 100° and less than 170° clockwise or counterclockwise with respect to the absorption axis direction of the polarizer A1. The first polarized partition may further include a polarizer A2 on a side opposite to the side of the retardation layer on which the polarizer A1 is arranged.

The above-mentioned section typically includes: a floor wall; a side wall including the second polarized partition; and a space partitioned with the walls. The section may be completely partitioned from the outside, or part thereof may be opened. In one embodiment, the above-mentioned section is a room including: the floor wall; the side wall including the second polarized partition; a ceiling wall; and a space partitioned with the walls.

The entire surface of the above-mentioned side wall may be the second polarized partition, or part thereof may be the second polarized partition. For example, when the section is a room having a rectangular shape in plan view, the room being defined with a floor wall, a ceiling wall, and two pairs of facing side walls, the entire surface of one, or each of two or more, of the side walls may include the second polarized partition (a so-called floor-to-ceiling window configuration), or the second polarized partition may be used as part of the side walls (e.g., a window portion or a door portion).

In the above-mentioned section, an image display apparatus configured to emit linearly polarized light from its display screen may be arranged on a side opposite to the side of the first polarized partition on which the second polarized partition is arranged. Contents displayed on the display screen can be shielded by arranging the first polarized partition so that the polarizer A1 is on a side closer to the image display apparatus with respect to the retardation layer, and so that the vibration direction of the linearly polarized light and the absorption axis direction of the polarizer A1 are parallel to each other.

Preferred specific examples of the above-mentioned section may include the sections (rooms) illustrated in FIG. 1, FIG. 2, FIG. 4, and FIG. 5. Of those, the sections illustrated in FIG. 1 and FIG. 4 are more preferred. Each of those sections may have a high design property because in observation from the outside of the section, light that has passed through the first polarized partition and the second polarized partition is observed as colored light.

In another embodiment, the above-mentioned section is partitioned with: a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and a second polarized partition including a polarizer B. A positional relationship between the first polarized partition and the second polarized partition is not limited as long as the light that has passed through both the first polarized partition and the second polarized partition can be viewed from the outside of the section. The first polarized partition and the second polarized partition are typically arranged with a predetermined interval therebetween.

The above-mentioned section typically includes: a floor wall; a first side wall including the first polarized partition; a second side wall including the second polarized partition; and a space partitioned with the walls. The section may be completely partitioned from the outside, or part thereof may be opened. In one embodiment, the above-mentioned section is a room including: the floor wall; the first side wall including the first polarized partition; the second side wall including the second polarized partition; a ceiling wall; a polarized partition-free side wall that may be optionally arranged; and a space partitioned with the walls.

The entire surface of each of the first side wall and the second side wall described above may be the polarized partition, or part thereof may be the polarized partition. For example, when the section is a room having a rectangular shape in plan view, the room being defined with a floor wall, a ceiling wall, and two pairs of facing side walls, the entire surface of one of the side walls includes the second polarized partition (a so-called floor-to-ceiling window configuration), and the first polarized partition may be used as the window of the side wall facing the side wall. In addition, for example, the first polarized partition and the second polarized partition may be used as the windows of two adjacent side walls.

Preferred specific examples of the above-mentioned section may include the sections (rooms) illustrated in FIG. 3 and FIG. 6.

The polarized partition set of the first embodiment described in the section B-1 or the polarized partition set of the second embodiment described in the section B-2 may be preferably used as the first polarized partition and the second polarized partition to be used in the formation of the above-mentioned section.

D. Polarized Partition

The first polarized partition (10a) described in the section B-1-1 and the first polarized partition (10b) described in the section B-2-1 may each be used not as a set with the second polarized partition but alone.

For example, when the first polarized partition (10a) is used as a desktop partition on a table having arranged thereon an image display apparatus, contents displayed on the display screen of the image display apparatus can be shielded by arranging the partition so that the polarizer A1 (12) is on a side closer to the image display apparatus with respect to the retardation layer (14), and so that the absorption axis direction of the polarizer A1 (12) is parallel to the vibration direction of linearly polarized light emitted from the display screen. In addition, with regard to the portion except the display screen, neutral transmitted light that is not colored can be obtained.

In addition, for example, when the first polarized partition (10b) is used as a desktop partition on a table having arranged thereon an image display apparatus, contents displayed on the display screen of the image display apparatus can be shielded by arranging the partition so that the polarizer A1 (12) is on a side closer to the image display apparatus with respect to the retardation layer (14), and so that the absorption axis direction of the polarizer A1 (12) is parallel to the vibration direction of linearly polarized light emitted from the display screen. In addition, with regard to the portion except the display screen, colored light resulting from a chromatic polarization phenomenon can be obtained.

### INDUSTRIAL APPLICABILITY

The polarized partition set of the present invention may be suitably used in the formation of a section that has a design property and is excellent in information security.

### REFERENCE SIGNS LIST

10 first polarized partition
12 polarizer A1
14 retardation layer
16 transparent substrate
18 polarizer A2
20 second polarized partition
22 polarizer B
100 polarized partition set
200 image display apparatus
300 section

1. A polarized partition set, comprising:
a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and
a second polarized partition, which includes a polarizer B and is arranged at a predetermined interval from the first polarized partition.

2. The polarized partition set according to claim 1, wherein the first polarized partition further includes a polarizer A2 on a side opposite to a side of the retardation layer on which the polarizer A1 is arranged.

3. The polarized partition set according to claim 1 or 2, wherein the first polarized partition is arranged so that the retardation layer is on a side closer to the second polarized partition with respect to the polarizer A1.

4. The polarized partition set according to claim 1, wherein the angle formed by the absorption axis direction of the polarizer A1 and the slow axis direction of the retardation layer in the first polarized partition is more than 10° and less than 80° clockwise or counterclockwise with respect to the absorption axis direction of the polarizer A1.

5. The polarized partition set according to claim 1, wherein the retardation layer has a configuration obtained by combining a plurality of retardation films.

6. A section, which is partitioned with a second polarized partition including a polarizer B,
wherein the section comprises arranged therein a first polarized partition including a polarizer A1 and a retardation layer having an in-plane retardation Re(550) of 100 nm or more, and
wherein an angle formed by an absorption axis direction of the polarizer A1 and a slow axis direction of the retardation layer in the first polarized partition is more than 10° and less than 80°, or more than 100° and less than 170° clockwise or counterclockwise with respect to the absorption axis direction of the polarizer A1.

7. The section according to claim 6, wherein the first polarized partition further includes a polarizer A2 on a side opposite to a side of the retardation layer on which the polarizer A1 is arranged.

8. The section according to claim 6 or 7, further comprising an image display apparatus arranged on a side opposite to a side of the first polarized partition on which the second polarized partition is arranged, the image display apparatus being configured to emit linearly polarized light from a display screen thereof.

9. A section, which is partitioned with:
a first polarized partition, which includes a polarizer A1 and a retardation layer having an in-plane retardation Re(550) of 100 nm or more, and in which an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1; and
a second polarized partition including a polarizer B.

10. The section according to claim 9, wherein the first polarized partition further includes a polarizer A2 on a side opposite to a side of the retardation layer on which the polarizer A1 is arranged.

11. A polarized partition, comprising:
a polarizer A1; and
a retardation layer having an in-plane retardation Re(550) of 100 nm or more,
wherein an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1.

12. A polarized partition, comprising in this order:
a polarizer A1;
a retardation layer having an in-plane retardation Re(550) of 100 nm or more; and
a polarizer A2,
wherein an angle formed by an absorption axis direction of the polarizer A1 and a slow axis direction of the retardation layer is more than 10° and less than 80°, or more than 100° and less than 170° clockwise or counterclockwise with respect to the absorption axis direction of the polarizer A1.
